(19) United States
(12) Patent Application Publication
(10) Pub. No.: US 2025/0200434 A1
(43) Pub. Date: Jun. 19, 2025

(54) A MECHANIZED INTELLECT ORCHESTRATION

(71) Applicant: Axita SHAH, Ahmedabad (IN)

(72) Inventors: Axita SHAH, Ahmedabad (IN); Jyoti PAREEK, Ahmedabad (IN)

(73) Assignee: Axita SHAH, Ahmedabad (IN)

(21) Appl. No.: 18/848,801

(22) PCT Filed: Mar. 20, 2023
(86) PCT No.: PCT/IN2023/050268

§ 371 Date: Sep. 19, 2024

(30) Foreign Application Priority Data
Mar. 21, 2022 (IN) 202221015523

(51) Int. Cl. G06N 20/00

(52) U.S. Cl. CPC G06N 20/00

(57) ABSTRACT

The present invention relates to a mechanized intellect orchestration process and a device that facilitates the process of problem solving and decision-making, further the present mechanized intellect orchestration mimics human intellect as mechanized intellect and acts as intellect mentor. The present mechanized intellect consists of Intellect Acquisition (IQ), Intellect Applying (IP) and intellect Examination (IX) Subdivision. The present Mechanized Intellect is nurtured by applying factors as functions to achieve subjective outcome. Said present mechanized intellect acquires, applies, and examines the solution.

### FIELD OF INVENTION

The present invention relates to a mechanized intellect orchestration that mimics human intellect as mechanized intellect and acts as intellect mentor. In particular the present invention relates to problem solving and decision-making process of a machine wherein the machine with human intervention learns the intellect abilities and its factors with the skill of intelligent retrieval from Diverse Computer Source through human connatural language interface.

### BACKGROUND OF INVENTION

Mimicking Human Intelligence to the machine can employ the field of the cognitive science. Intelligence is beyond memory while Intellect operates with memory and identity. Intellectual engine is designed to solve complex problem of working of intellect by managing it. Intellectual Engine provides knowledge and utilize it for problem solving and decision making. Knowledge based Intellectual engine either learns from the provided rules or it learns by itself using machine learning tactics.

Knowledge Representation is sub-part of intelligent systems of Artificial Intelligence approach. To represent knowledge as a part of intellect, it should be considered from multi-dimensional to cover the important aspects of intellect. However, The Conventional method fails to provide complete intellect orchestration of configuring, coordinating, and managing the intellect. This is provided as an orchestration process by Mechanized Intellect abilities and factors.

To utilize the existing content, there are fields as data retrieval, information retrieval and knowledge retrieval. Requesting for information from data, information or knowledge and producing the solution. Data Retrieval retrieves from Structured Data, Information Retrieval retrieves from semi-structured or unstructured data, while knowledge retrieval retrieves from knowledge sources. Several Approaches retrieve from the diverse sources after integration. In addition, the conventional process of retrieving after integration per se, and indexing is time consuming, tedious, and error prone. Even there is a conventional question-answering method that retrieves from varied sources by utilizing pre-defined patterns. However, the conventional approach fails to retrieve from diverse sources intelligently. Henceforth, the conventional automated approach fails to acquire, apply, and evaluate the intellect.

Therefore, there is an unmet need of a method for mechanized intellect, that acquires, apply, examines, and evaluate the intellect efficiently.

### PRIOR ART AND ITS DISADVANTAGES

U.S. Pat. No. 8,935,277B2 provides context aware question answering (QA) system. The question may be a business intelligence question that is expressed in a natural language. The parsed question is matched to a pattern from a number of generated patterns. A Pre-defined technical query associated with the matched pattern is processed to retrieve data relevant to the question from a number of data sources. The QA System generates an answer to the question based on retrieved data.

However, the prior art generates the solution based on pattern matching technique. In addition, the prior art fails to consider multiple factors and divergence approach of natural query cognition.

### DISADVANTAGES OF PRIOR ART

The prior art suffers from some or all of the following disadvantages:
The Prior art fail to provide an orchestration process that mimics multi-dimensional intellect as mechanized intellect and acts as Intellect Mentor.
The Prior art fails to provide mechanized intellect factors that ultimately retrieve intelligently from Diverse Computer Sources without content conversion.
The Prior art fails to mimic a mechanized intellect process, to acquire, apply and evaluate the solution.
The Prior art fails to generate intermediate components of human connatural language-based user's request cognition based on Particulars with Precepts approach by using MI divergence function of Mechanized Intellect factors.
The Prior art fails to generate generic multi-dimensional eta-content outcome of the computer resources to determine the computer resource.
The Prior art fails to cognize and retain meta subjective outcome.
The Prior art fails to provide hierarchical tacit particulars with precepts of determining the computer resource. Even the prior art fails to consider one of the precepts that is determining the computer resource based on Data, Information, Knowledge, and Wisdom hierarchy of the Computer Resource.
The Prior art fails to generate Generic Query Conversion from natural language processed user's request.
The Prior art fails to consider Particulars with Precepts approach to generate direct solution by using MI convergence function for, determining Computer Resource, Generic Query Conversion, Result Producer Assistance.

### OBJECTS OF THE INVENTION

1. The Primary object of the present invention is to provide an orchestration process that mimics human intellect and provides solution to the problems for decision making.

2. Another object of the present invention is to provide orchestration process of mechanized intellect by configuring, coordinating, and managing.

3. Another object of the present invention is to acquire, apply, and examine mechanized intellect.

4. Yet another object of the present invention is to generate generic meta model of the mechanized intellect subjective factors.

5. Yet another object of the present invention is to provide an intelligent retrieval skill that provides problem solving and facilitates the decision making.

6. Yet another object of the present invention is to provide a mechanism of intelligent retrieval from diverse sources while utilizing human connatural language.

7. Yet another object of the present invention is to analyze MI way human connatural language-based user's request by utilizing MI divergence function.

8. Yet another object of the present invention is to provide hierarchical tacit knowledge of determining the computer resource, and to provide generic query conversion and result producer by utilizing MI Convergence function and Particulars with Precepts Approach.

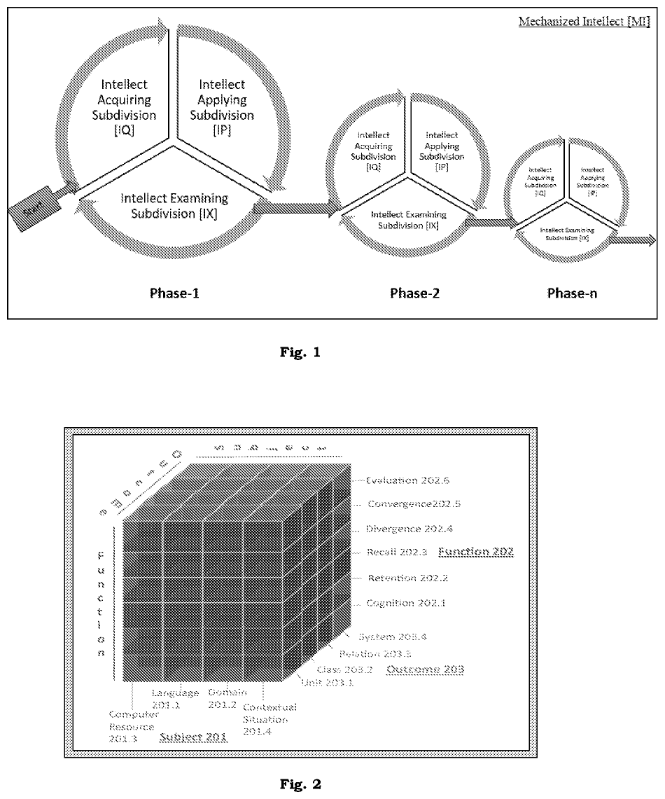

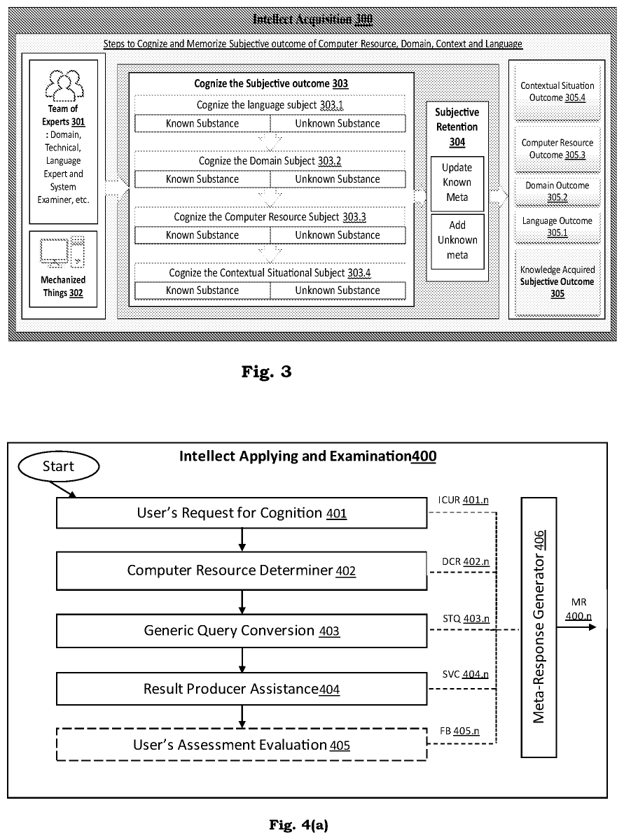

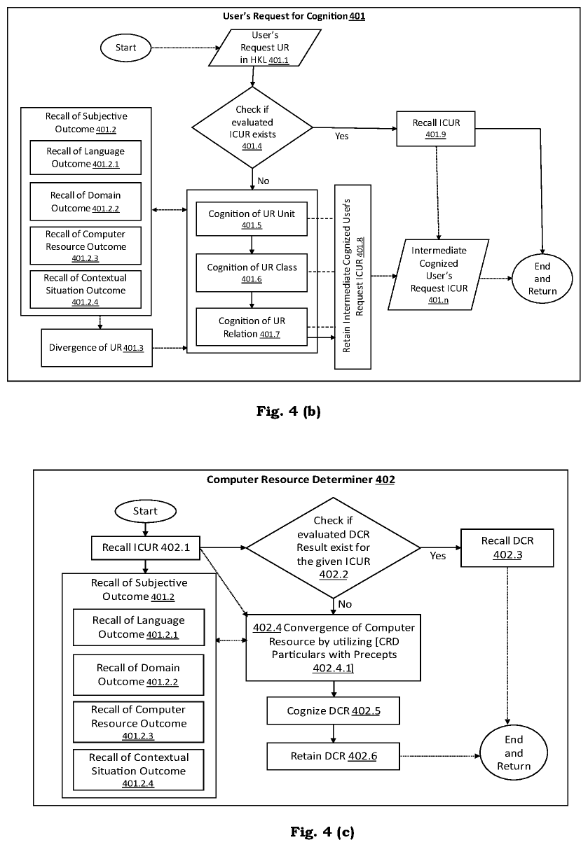

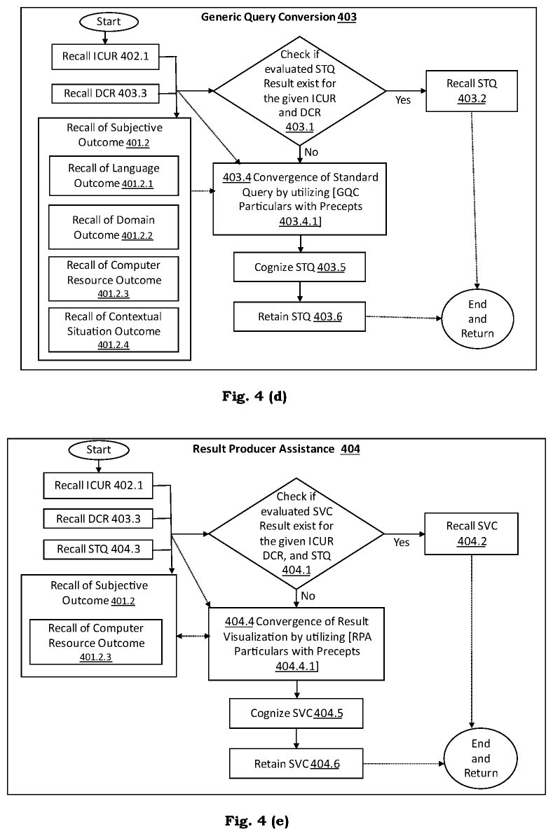

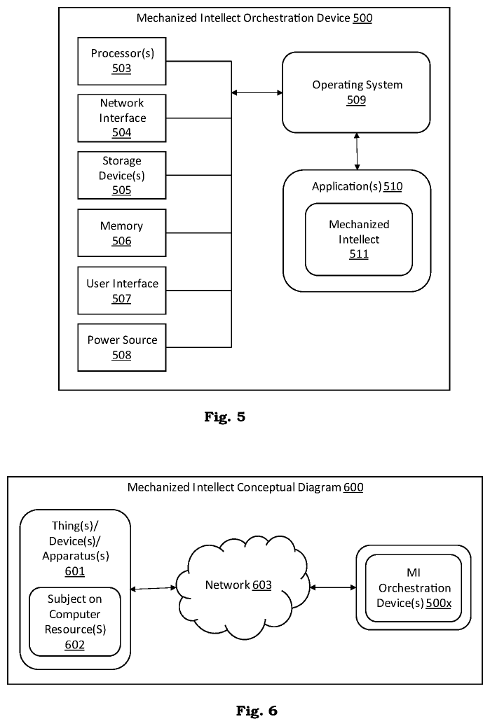

### BRIEF DESCRIPTION OF DRAWING

| | |
|---|---|
| FIG. 1 | Shows the sub-divisional abilities of mechanized intellect |
| FIG. 2 | Shows the meta model of the mechanized intellect factors. |
| FIG. 3 | Shows the block diagram for the acquisition of the intellect |
| | for intelligent retrieval. |
| FIG. 4(a) | Shows the applying and the examining of the mechanized |
| | intellect. |
| FIG. 4 (b) | Shows the course of actions of human connatural |
| | language request for the cognition. |
| FIG. 4(c) | Shows the eclectic practice of determining the computer |
| | resource. |
| FIG. 4(d) | Shows the constituents of the conversion of generic query |
| | to the standard technical query. |
| FIG. 4 (e) | Shows the comprehensive practice for generating result |
| | with the help of result producer assistance. |
| FIG. 5 | Shows the orchestration environment representation of the |
| | present invention. |
| FIG. 6 | Shows the conceptual diagram illustrating an orchestration |
| | device connected to the network and with repositories. |

### Meaning of Reference Numerals of Said Component of Present Mechanized Intellect for Machine Learning,

IQ: Intellect acquiring subdivision
IX: Intellect Examining Subdivision
IP: Intellect Applying Subdivision
S: Subjects
SL: Subject Language
SD: Subject Domain
SC: Subject computer resource
SS: Subject Contextual situation
F: Functions
FC: Function Cognition
FT: Function Retention
FR: Function Recall
FD: Function Divergence
FC: Function Convergence
FE: Function evaluation
O: Outcome
OU: Outcome unit
OC: Outcome Class
OR: Output relation
OS: output system
300: Intellect Acquisition
301: Team of experts
302: mechanized things
303: cognizing the subjective outcome
303.1: cognizing of language subject
303.2: cognizing of domain subject
303.3: cognizing of computer resource subject
303.4: cognizing of contextual situation subject
303.5: Particulars with Precepts Approach for Intellect Acquisition
304: Subjective Retention
305: subjective outcome
400: Intellect Applying and Examination for Intelligent Retrieval Skill 401: User's Request for Cognition
401.1: User's Request in Human Connatural Language
401.2: Recall of Subjective Outcome
401.2.1: Recall of Language Outcome
401.2.2: Recall of Domain Outcome
401.2.3: Recall of Computer Resource Outcome
401.2.4: Recall of Contextual Situation Outcome
401.3: Divergence of User's Request
401.4: Check if evaluated ICUR exists
401.5: Cognition of UR Unit
401.6: Cognition of UR Class
401.7: Cognition of UR Relation
401.8: Retain ICUR
401.9: Recall ICUR
401.n: intermediate cognized user's request
402: Computer Resource Determiner
402.1: recall intermediate cognized user request
402.2: check if evaluated DCR Result exists
402.3: recall Determined Computer Resource
402.4: convergence of computer resource
402.4.1: Particular with Precepts for Computer Resource Determiner
402.5: Cognized Determined Computer Resource
402.6: Retained Determined Computer Resource
402.n: Determined Computer resource
403: Generic Query Conversion
403.1: checks evaluated standard technical query exists
403.2: Recall the Standard Technical Query
403.3: Recall Determined Computer Resource
403.4: Convergence of Standard Technical Query
403.4.1: Generic Query Conversion Particulars with Precepts
403.5: Cognize Standard Technical Query
403.6: Retain Standard Technical Query
404: Result Producer Assistance
404.1: check if standard visualized component exists for the given user's request
404.2: recall the Standard Visualized Component
404.3: recall Standard Technical Query
404.4: Convergence of Standard Result Visualization
404.4.1: Particulars with Precepts for Result Producer Assistance
404.5 cognize Standard Visualized Component
404.6: retain Standard Visualized Component
404.n: Suggested Visualized Component
405: User's Assessment Evaluation
500: mechanized intellect orchestration device
503: processor
504: network interface
505: storage device
506: Memory
507: user interface
508: power source
509: operating system
510: an application
511: Mechanized Intellect Solution
600: MI Conceptual Diagram
601: Thing/apparatus/device
602: computer resource
603: network

### SUMMARY OF THE INVENTION

The present embodiment of Mechanized Intellect (MI) as orchestration process at orchestration device and in another example as MI orchestration device and in another example as means of MI orchestration system aids for the Intellect Orchestration to human for the problem solving and decision making. Intellect nurtures by acquiring, applying, and examining abilities. Hence, This Mechanized Intellect consists of Intellect Acquisition, Application and Examination Subdivision. Mechanized Intellect is nurtured by applying its factors as functions to achieve subjective outcome. Intellect is acquired mechanically for the identified subjects. Identified Subjects are Domain, Language, Computer Resource, and Contextual Situation. Outcome after applying functions on Subject are actual or transformed Unit, Class, Relation, and System. Intellect Acquisition happens with the subjective cognition and retention function. When any problem arises or decision to be made, User requests to MI that requires Intelligent Retrieval Skill of Intellect application. To retrieve the solution, User requests via human connatural language (HKL) interface, processing the user request via Subjective Recall, and Divergence function from acquired intellect; Determining the Computer Resource where the response exists majorly with convergence function, Generic Query Conversion for technical query Conversion from HKL using Convergence function, and Result Producer Assistance to produce the result via Subjective Recall, and Convergence function. This Application of intellect is achieved with the help of Particulars with Precepts Approach where problem is resolved, and decision is made not only with precepts but with the usage of particulars with precepts. And at the end Intelligent Retrieval Skill is examined by the User's Assessment Evaluation via Subjective Recall, and Evaluation Function.

### DETAILED DESCRIPTION OF INVENTION

Embodiments of the present disclosure present solution to one or more of the above-mentioned technical problems recognized by the inventor in conventional practices and existing state of the art. The accompanying drawings are a part of this complete specification and illustrate one or more embodiments of the invention. Preferred embodiments of the invention are described in the following with reference to the drawings, which are for the purpose of illustrating the present preferred embodiments of the invention and not for the purpose of limiting the same.

The following detailed description illustrates embodiments of the present disclosure and ways in which the disclosed embodiments can be implemented. Although some modes of carrying out the present disclosure have been disclosed, those skilled in the art would recognize that other embodiments for carrying out or practicing the present disclosure are also possible. Hence, its features, applications, and advantages will be apparent. Referring to FIG. 1. The embodiment of the present invention is to provide an orchestration process that configures, coordinates and manages Mechanized Intellect (MI). It first acquires the intellect, through the process of MI factors and utilizes the acquired intellect for the retrieval. Said orchestration works by three sub-divisional means of Intellects are namely; acquisition, examination and application abilities. MI also provides the intelligent retrieval skill to retrieve from diverse computer sources. Said intellect acquiring subdivision (IQ) acquires the knowledge of the required element, its generic attributes, specific characteristics, its functions and relations with contrasting elements, with the help of human expert teams or mechanized things. The intellect examining subdivision (IX) thoroughly examines the acquired knowledge by utilizing the intellect applying subdivision (IP). Thus, Intellect Examining Subdivision (IX) and Intellect Applying Subdivision (IP) are used hence and forth. Further said intellect examining subdivision (IX) simultaneously recalls the acquired subjects and validates the obtained result. Said Intellect Examining Subdivision (IX) and Intellect Applying Subdivision [IP] are dependent on Intellect Acquiring Subdivision (IQ). Hence, Intellect Acquiring Subdivision (IQ) is the forbearer of (IX) and (IPs). Said orchestration process acquires said intellect abilities through the virtue of intellect factors that improves the cognition and learning by Particulars with Precepts (PwP) Approach by enhancing the problem solving and the decision-making ability of the said computing process, through intelligent retrieval.

Referring to FIG. 2 another embodiment of the present invention, the factors of mechanized intellect are based on functions, subjects and outcomes. Intellect Acquiring Subdivision (IQ) Ability mimics functions of human mind such as Identity, Cognition by Particulars with Precepts (Scope Rules) and memorize as Mind Map in Memory. IQ requires to acquire an intellect using factors of intellect by applying functions (F) on its various subjects(S), based on its properties and outcome (O) category. This ability is acquired by competing its functions on subjects to derive subjective outcome.

Another embodiment shows a Single MI Device performs MI abilities such as IQ, IP and/or IX by using its factors with Intelligent Retrieval Skill as MI system at MI device. In Some Example One or more multiple devices distributed or block chained MI abilities such as IQ, IP and/or IX as separate MI modules. In some example, One of the MI device is treated as server to perform MI IQ, and IX ability; and other devices perform Intelligent Retrieval skill via IP ability.

The intellect factor subject(S) is related to the area of the information that facilitates intellect. All the intellectual functions and the activities are performed on said subject factor to acquire the subjective outcome. Said subject factor differentiates area of the information for developing mechanized intellect. Said subject dimension comprises of four sub-factors namely: language (SL), Domain (SD), Computer resources (SC), Contextual Situation (SS).

The language (SL) plays an important role to know subjective area of information to acquire an intellect. Intellect Acquiring Subdivision (IQ) requires to apply functions on language for linguistic ability. Said retrieval system further identifies the domain (SD) to understand where the knowledge belongs to, said domain (SD) identifies the boundary of the knowledge acquisition and application. Said Intellect Applying Subdivision (IP) applies the acquired domain knowledge for intelligent retrieval process to get an idea of topics of the complete domain. The subjective intellect ability also depends on the computer resource (SC). There is an exponential evolution in diverse computer resources in Information technology industry. Kinds of Computer Resource include but are not limited to, structured, semi-structured, unstructured data, information, knowledge, wisdom, etc. This diversification is based on its generic and specific characteristics, attributes with its properties. Intellect Acquiring Subdivision (IQ) acquire meta knowledge of these existing diverse computer resources for further retrieval. After the identification of language (SL), Domain (SD), and Computer resources (SC), the contextual situation (SS) is acquired. Contextual Situation [SS] is the situation in which certain action happens or certain substance is in the given state. Said Contextual Situation [SS] depends on demography, time, weather, or news to acquire intellect. The order of acquired knowledge is first the language (SL) is acquired, then the domain (SD) of an interest is considered, then represented as computer resource (SC) and apply the solution in contextual situation (SS). Even there would be cross-relation among these four subjects. To acquire, apply, and examine the intellect, the intellect factor related to Function (F) is required. Said Function factor (F) is an intellectual factor is a fundamental dimensional category to perform operation or processes on the subject. Said function factor (F) depends on various sub factors namely Cognition (FC), Retention (FT), Recall (FR), Divergence (FD), Convergence (FV), and Evaluation (FE). The Cognition sub-factor [FC] is the ability to know the subjects with its various forms by understanding, discovery, and comprehension and become aware of information. After cognizing the information is retained with the help of sub-factor retention (FT) that remembers substances with its generic and specific properties. Encoding of the cognized subjects is the required function for Intellect Acquisition (300). Retention sub-factor (FT) encodes, represents, records, and organizes the subjective knowledge. The retained information is retrieved by utilizing sub-factor Recall (FR) that functions to retrieves already retained subjective knowledge. Recall (FR) requires to decode the information after receiving it in encoded format for further processes. After cognition and retention, it is required to provide the given problem to generate the solution, Said method after retrieving the problem provides multiple solution to the problems through divergence sub-factor (FD) that generates multiple alternatives from the given basic subjective information. Said divergence sub-factor (FD) is an operation that access multiple solutions to a problem.

Thereafter the process of selection of a single solution is followed with the help of a sub-factor, namely Convergence (FV), that arrives at one single solution to a problem by generating logical conclusion from given information. The solution obtained is evaluated through the sub-factor Evaluation (FE) that evaluates whether or not the obtained solution is identical, adequate, consistent, valid, or desirable based on its applied operation.

To acquire, apply and examine the intellect, outcome is produced through the factor Outcome (O) that refers to the resultant forms in which subject information is operated by the functions. Said outcome (O) is divided into four sub-factors namely: unit (OU), class (OC), relation (OR), system (OS). The unit (OU) is an item of the processed resultant subject based on applied function. It identifies the ability to perceive the unit in the subject area of information. Subject Unit is with actual or transformed or implicated content. After unit is determined the class of the subject is determined, through the sub-factor class (OC). Said class (OC) of the subjects shares the common properties or attributes between units. Class result classifies the subject and makes meaningful group of similar subject units. Class is created manually by labeled class or automatically by machine learning. After determining the class of the subjects, it is important to determine the relations between the various similar subjects and the opposite subjects. The relation is determined utilizing the sub-factor relation (OR), that provides connections between items of information based upon variables either definable or implicated. Relation is the association, inheritance, opposites, sequences, inferences, transformation, analogies, or any other relationship between pair of units. Relationship among the units of subject provides related knowledge. After defining the relations, the information is organized into a meaningful structure through the sub-factor system (OS). Said subfactor system (OS) is a pattern or gestalt having semantic structure or network of interrelated multiple relations. System is a composition of relations, classes, and units into a larger and more meaningful structure. This connection may be between two or more than two units, and connection of the relationship for the semantics. The intellect thus obtained comprises of 4 subjects(S), 6 functions (F) and 4 outcomes (O) as 96 mechanized intellect factors of intellectual abilities.

Referring to FIG. 3, another embodiment of the present invention provides the working of Intellect Acquiring Subdivision (IQ). The steps include acquiring of knowledge with the help of team of experts (301), and mechanized things (302), cognizing the subjective outcome (303) followed by the retention of acquired subjective knowledge (304) and subjective outcome based on the cognized and retained knowledge (305).

Wherein Team of Experts (301) include but are not limited to Domain Expert, Language Expert, and Technical Expert. IQ utilize the existing knowledge that might be available as a part of Mechanized

Thing (302). Mechanized Thing (302) may be apparatus or device or thing. Said expert team (301) and mechanized thing (302) are considered as input provider to the Intellect Acquiring Subdivision (IQ). Said expert team (301) and mechanized thing (302) make an acquaintance of subject's informative knowledge that includes but are not limited to, auditory, visual, symbolic, olfactory, behavioral, semantic, gustatory, and haptic, through the perception and conception, and that is ultimately generated via the content provided as a part of diverse digitized Computer Resources. The acquired knowledge is further cognized through the cognition of Subjective Outcome (303) and retained though the subjective retention (304), the retained knowledge is converted to outcome through the Subjective Outcome (305) that consists of Subjective Cognized and retained knowledge outcome with its properties having attribute, characteristics. The cognition and the retention of knowledge is determined through cognition of language subject (303.1), cognition of domain subject (303.2), cognition of computer resource subject (303.3) and cognition of contextual situation subject (303.4). The cognition of language subject (303.1) is utilized to identify the language units that includes but are not limited to, character, token, language, etc. Language Cognition (303.1) analyze the token by its language, Form, Number, Gender, Case, Person, Mood, Tense, Voice, and Parts of Tokens such as Part of Speech and other tokens such as Punctuation, sign and symbol, number and figure writing; and residuals. Language Cognition (303.1) also identifies Parts of speech as Noun, Pronoun, Adjective, Verb, Adverb, Conjunction and kinds of sub Parts of Speech of token. Language Cognition (303.1) identifies system outcome of language first, then identifies relations between sentences, sentence classification then identifies tokens, classes among tokens, relation between tokens, and character units, classes, relations, and system outcome.

TABLE 1
Factors of Language Outcome

| Language Subjective | |
|---|---|
| Outcome0020Factors | Properties |
| Cognition of Language Unit and | Character, Token, and Sentence Units |
| Retention of Language Unit | |
| Cognition of Language Class and | Character Classification, Token |
| Retention of Language Class | Classification as an example noun Parts |
| | of Speech, and Sentence Differentia |
| Cognition of Language Relation | Relation between Character for Spelling; |
| and Retention of Language | and for morphological and lexical |
| Relation | analysis, Relation among Token for |
| | Syntactic and semantic Detection, and |
| | Semantic Relationship among sentences |
| Cognition of Language System | Language Components Per se and |
| and Retention of Language | Network with other areas of informative |
| System | subjects such as Domain, Contextual |
| | Situation, and Computer Resource |

Table 1 shows the various factors affecting the cognizing and the retention of language outcome that shows cognition and the retention of the language unit is based on character, token and sentence units. The cognition and the retention of language class is determined by character classification, token classification and parts of speech. The cognition and the retention of the language elation is determined by determining the relation between the characters, for spelling, morphological and lexical analysis. And further after determining the unit class and the relation between the cognition and retention of system is determined by determining the properties such as Language Components Per se and Network with other areas of informative subjects. After cognizing and retaining language knowledge at various stages the language outcome (305.1) is produced, that expresses the language Analysis of character, token, and Sentence Differentia.

After cognizing and retaining the language subject, the domain (303.2) is cognized and retained for subjective domain outcome (305.2). The classical and modern knowledge branches of arts and skills in commerce, science, and arts, hierarchical domain (303.2) knowledge is generated that assist in intellect acquisition. Domain (303.2) identifies the unit of the acquired language knowledge compare it with opposite Domains and establishes the relation between the variable domains.

TABLE 2
Factors of domain Outcome

| Domain Subjective | |
|---|---|
| Outcome Factors | Properties |
| Cognition of Domain Unit and | Domain unit Explanation via natural |
| Retention of Domain Unit | language Components |
| Cognition of Domain Class and | Domain Classes and sub classes such |
| Retention of Domain Class | as arts, commerce, science |
| Cognition of Domain Relation | Relation within, between, or opposites |
| and Retention of Domain | of domain |
| Relation | |
| Cognition of Domain System | Domain Components Per se and |
| and Retention of Domain | Network with other areas of informative |
| System | subjects such as language, Contextual |
| | Situation, and Computer Resource |

Table 2 shows how various factors affect the cognition and the retention of domain outcome. The cognition and the retention of the domain unit is based on explanation of the domain with the help of language components. After determining the domain unit the class and the sub-class of the domain is determined. Further the relation between the various different domains is established and the knowledge of the same is cognized and retained. After cognizing and retaining language knowledge at various stages the domain outcome (305.2) is produced that determines the domain of the knowledge acquired.

After the subjective domain outcome (305.2), the computer resource is cognized and retained to obtain subjective computer resource outcome (305.3). Computer Resource is a software construct that facilitates content storage and retrieval. Several computer resources mechanized things include but are not limited to, Multimedia audio, video, image; structured transactional, aggregated, relational or hierarchical or network data or information; unstructured text, semistructured markup, separated values, etc. Computer Resources vary its storage based on the specified facets of subject wise content differentiation. Cognition of Computer Resource Subject (303.3) factor is essential to acquire an intellect. Each computer resource has its different formation of metadata even for identifying computer resource and retrieving content, Meta-content plays an important role. Hence, to recall precisely Computer resource content with its meta-content needs classified remembrance in memory. Various Computer Resources are stored for further access of information and these resources' meta properties are required to retain as Subjective Retention (304) for further intelligent actions. Intellect Acquiring Subdivision (IQ) memorize whatever it has cognized or learn the subjects via human mind or machine learning. Memory is the ability by its two sub functions i.e., Memory Recording and Recall. Once the Cognition happens, its Meta-property is stored as multi-variated hierarchical system structure this Memorized Meta is further useful as determination of outcome Computer Resource.

TABLE 3
Factors of Computer Resource Outcome

| CR Subjective Outcome | |
|---|---|
| Factors | Properties |
| Cognition of Computer | Identification Property: Name, Reflection Image, |
| Resource Unit and | Website, Mime Type |
| Retention of Computer | Authorization Property: Connection URL, Login, |
| Resource Unit | Password, Properties |
| | Administrative Access: Access Type, |
| | Visualization Type, Meta Structure Type, |
| | Retrieval Type, Is SubRetrieval, Is Significant or |
| | not, Is valid or not, Is existent or not, Is |
| | Extinction or not |
| | Descriptive Property: Is Author or Editor, |
| | Proprietor Name, Cause/Purpose/Intention for |
| | resource creation, Nature of Resource, Time: |
| | Start, refresh and end time, Description |
| | Statistics Property: Similar kinds of count, size |
| Cognition of Computer | Technical, Logical, Storage, Data, Source, |
| Resource Class and | Producer, Usage, Process, Stream, Summary, |
| Retention of Computer | Technical Sub-model, Size, Perceptional, Content |
| Resource Class | Class- 1, 2 |
| Cognition of Computer | Unstructured to structured hierarchy, Similarity |
| Resource Relation and | Content, Qualitative Relation |
| Retention of Computer | |
| Resource Relation | |
| Cognition of Computer | Computer Resource Components Per se and |
| Resource System and | Network with other areas of informative subjects |
| Retention of Computer | such as language, domain, and Contextual |
| Resource System | Situation |

Table 3 show the various ways to encode the meta and retain the same. Said meta content is proposed and divided into level wise hierarchy into unit, class, relational and system properties of meta-content of any computer resource as follows: Cognition of Computer Resource Unit, Cognition of Computer Resource Class, Cognition of Computer Resource Relation, and Cognition of Computer Resource System. This Cognized Computer Resource has generic (g) and specific(s) property both to identify the resource. These g and s factors are very useful in two major abilities that is computer resource determiner and generic query conversion. The Standardized g and s (gs) factor Metadata for electronic source needs to cognize for Intellect Application and Examination.

Said cognition of Domain (303.2) and Computer Resource (303.3) Intellect with language (303.1) knowledge is always connected with contextual situation. Cognition of Contextual Situation subject (303.4) assist the knowledge which ultimately helps in acquiring intellect. Components for Contextual Situation includes but are not limited to location, news, weather, government, demography, etc. Intellect Acquiring Subdivision (IQ) cognize meta-content of Contextual Situation and retain it for further Intellect application and examination.

TABLE 4
Factors of Contextual Situation Outcome

| Contextual Situation | |
|---|---|
| Subjective Outcome Factors | Properties |
| Cognition of Contextual | Properties for Situational unit such as |
| Situation Unit and Retention of | Time, location, news, demography, |
| Contextual Situation Unit | geography |
| Cognition of Contextual | Classes of situation such as |
| Situation Class and Retention of | past/present/future Time; |
| Contextual Situation Class | Actual/Predicted Situation |
| Cognition of Contextual | Relation within, between or opposites |
| Situation Relation and Retention | of Contextual Situation |
| of Contextual Situation Relation | |
| Cognition of Contextual | Contextual Situation Components Per |
| Situation System and Retention | se and Network with other areas of |
| of Contextual Situation System | informative subjects such as language, |
| | domain, and Computer Resource |

Table 4 shows that Knowledge is acquired and applied in its different Contextual situation. Cognition of Contextual Situation Unit, Cognition of Contextual Situation Class, Cognition of Contextual Situation Relation, and Cognition of Contextual Situation System generates Contextual Situation Outcome (305.4). In other examples, fewer or more elements or factors may be utilized and/or extended within and/or outside in the example of Table 1 to Table 4.

Based on the determined Intellect Acquisition Subdivision (IQ), it indicates When any problem arises, there are kinds of operational factors required to reach a solution. Before the advancement is done towards a solution, Problem needs to be understood and structured as a system outcome.

Having cognized the problem, Alternative solutions can be generated as a divergent production function of outcome or if unique solution exists based on adequate information, when there will be a convergent production. Throughout the problem solving, there is an evaluation mechanism which either accepts or rejects the cognition of the problem and its generated solution.

Referring to FIG. 4(a) to FIG. 4(e) another embodiment of the present invention illustrates the Intelligent Retrieval skill by utilizing Intellect Applying and Intellect Examination (400), the process of applying and/or examining intellect. Intelligent Retrieval follows the process to acquire intellect via developing sub-abilities as User's Request for Cognition (401), Computer Resource Determiner (402), Generic Query Conversion (403), Result Producer Assistance (404) and User's Assessment Evaluation (405); and generate (400.n) as MetaResponse (MR) that is utilized for Intellect examination process.

The user feeds the problem and requests for the solution to the problem for problem solving and decision making via User's Request for Cognition (401) segment. A Request for Cognition (401) is a Human Connatural Language [HKL] request to cognize the user request for producing the knowledge. Human gives an answer sometimes by understanding the whole question, sometimes by understanding noun, verb as a part of query or sometimes by identifying keywords from the request or sometimes link knowledge and generates an answer. Based on the specified term definitions, here we catalogue these terms in higher-level hierarchy as a Request for Cognition (RFC). A Request for Cognition (RFC) is a standard request whose purpose is to cognize the user request for producing the knowledge. Before satisfying user's request in a form of response, it is vital to realize panorama of RFC from every possible perspective. One UR contain multiple queries. One Query contain multiple sentences which are formed from words. A Group of correctly sequenced words that makes a complete sense is called a Sentence. Words arranged in a certain order that have a meaning is called as sentence and one RFC may consists of multiple sentences.

The proposed solution cognizes the user's request subject wise. Identifying type of user's request include but are not limited to search, explore, question, study, examine, scrutinize, investigate, enquiries, etc. User is requested in natural language as User's Request (401.1) it is provided as an input to Request for Cognition (401), and that ultimately generates Intermediate Cognized User's Request (401.n). (401.4) checks if evaluated ICUR exists or not for the given UR. If it exists, it recalls ICUR (401.9), and ends; but if it doesn't exist, it moves towards the cognition of user's request outcome. Cognition of User's Request Outcome is acquired by Cognition of User's Request Unit (401.5), User's Request Class (401.6), and User's Request Relation (401.7). Cognition of User's Request Outcome is achieved with the help of Recall of Subjective Outcome (401.2) and Divergence of User's Request Outcome (401.3). Request for Cognition (401) Cognize the semantic components of the UR, the grammatical components of User's Request as whether the syntax of the sentence is correct or not; identifies sentence's differentia lexically and syntactically, even pre-process the tokens of the sentence such as spelling, abbreviation; Parse the tokens of sentence by different classifications as the parts of speech; and finally generates intermediate analyzed components for user's Request. This Analyzed Essential elements of Request for Cognition (401) gets stored as Intermediate Cognized User Request [ICUR] (401.n) in semi-structured markup language Format.

Divergence of User's Request Outcome (401.3) provide varied probable combination of classes to cognize the user's Request thoroughly. Divergence of User's Request (401.3) uses Recall function of Subjective Outcome (401.2) to generate multiple solutions for the cognition of the User's Request. Recall function of Subjective Outcome (401.2) recalls Language Outcome (401.2.1), recall Domain Outcome (401.2.2), recall Computer Resource Outcome (401.2.3), and recall Contextual Situation Outcome (401.2.4) to understand the user's request branching. Cognition of user's request Unit (401.4) is considered as knowledge of linguistic units based on domain and contextual situation. Language Scanner Parser, and Sentence Boundary Identifier is used to identify users' request units such as characters, tokens, and sentences consequently. Properties of all these three linguistic units is recalled from retained Subjective Outcome. Cognition of users' request class (401.5) classifies users' request based on language, domain, and context. Cognition of users' request relation (401.6) relates the components of users' request within and over. Language Relation of characters makes word, relation of word tokens provides semantics of User's Request. Relation between tokens identify the action or state of specified requested verbal situation. Relation of two sentences of one request is effective to identify the request's semantics. Relation between tokens of the sentence guides the grammatical syntax of the request which further helpful to cognize the user's request. Retention of the cognized user's request (401.7) is considered for further (IP) and (IX) Processes. Retention of the cognized user's request (401.7) encodes and records the information in proper structure as Intermediate Cognized User's Request.

Intermediate Cognized User Request (401.n) consists of encoded information of properties of unit, class, and relation of UR as Cognition of user's request Unit (401.4), User's Request Class (401.5), and User's Request Relation (401.6). Format of Intermediate Cognized User's Request would be hierarchical markup and keyvalue pair-based structure.

Further the Computer Resource Determiner (402) selects the resource based on the acquired knowledge and user's RFC as Human Connatural language [HKL] query. It determines the Computer Resource based on the existing evaluated Determined Computer resource (402.n) based on given UR or determine or by knowledge of Intermediate Cognized User's Request (401.n). For Computer Resource Determiner (402) the cognized users' request is recalled, evaluated to check whether it already exists. If it exists, it Recalls the Determined Computer Resource (402.3). Determined Computer Resource has the selected computer resource which contain the entry for computer resource having solution of user's request. Once the Determined Computer Resource is cognized, Function (402) ends. But if Existing Evaluated result does not exist, then the process moves to the (402.5) for the Convergence of Computer Resource by utilizing Computer Resource Determiner (402) Particulars with Precepts (402.5.1). (402.5) even require the Subjective Outcome (305) knowledge. It uses recall of Subjective Outcome (401.2), and It recalls Intermediate Cognized User's Request (401.n), (402.1 Computer Resource Determiner Particular with Precepts (402.5.1) includes precepts but are not limited to user's request type such as command question; classes of linguistic units of user's request; one of the content class identifying data, information, knowledge, or wisdom.

Generic Query Conversion (403) applies process of converting Natural Language Query to Technical Query. User's Natural language Request may suffice from any of the connected computer resource. Each Computer Resource has different means of connection and retrieval.

For Generic Query Conversion (403), Recall the intermediate cognized user request-(401.n) (402.1) function would be performed. After recalling cognized user's request, it checks if evaluated result exists for the given intermediate cognized user request (401.n) and 15 Determined Computer Resource (402.n) as the function of (403.1). If it exists, it recalls the standard technical query (403.2). Standard Technical Query has the technical query for the selected computer resource and given intermediate cognized user request which contain the entry for technical query having knowledge of how to access the computer resource for generating the solution. Once the Standard Technical Query is cognized, function (403) ends. But if existing evaluated result does not exist, then the process moves to the (403.4) for the convergence of standard technical query by utilizing Generic Query Conversion (403) particulars with precepts (403.4.1). (403.4) even require the subjective outcome (305) knowledge. It recall intermediate cognized user request-(401.n) (402.1), recall of subjective outcome (402.4) as recall language outcome (402.4.1), recall domain outcome (402.4.2), recall computer resource outcome (402.4.3), and recall contextual situation outcome (402.4.4), and even it recalls determined computer resource (403.3); that decisively cognizes and retains Standard Technical Query.

Result Producer Assistance (404) assist in identifying Suggested Visualized Component (404.n), For Result Producer Assistance (404), Recall the Intermediate Cognized User's Request-(401.n) (402.1) function would be performed. After recalling required components based on user's request, it checks if evaluated result exists for the given Intermediate Cognized User's Request (401.n), determined computer resource (402.n), and standard technical query (403.n) as the function of (404.1). If it exists, it recalls the Standard Visualized Component (404.2). Standard Visualized

Component (404.2) has the Visualize Component Identification for the given component which contain the entry for visualization component. Visualization Components include but are not limited to, single or multi-value; text, n-dimensional tabular, chart, shapes, pictorial marking, textual, graph, image, audio, video, etc. Once the standard visualized component is cognized, function (404) ends. But if Existing Evaluated result does not exist, then the process moves to the (404.4) for the Convergence of Standard Visualized Component by utilizing result producer assistance particulars with Precepts (404.4.1). (404.4) even require the knowledge of Computer Resource Outcome (402.4.3) as Subjective Outcome (305) knowledge.

Result Producer Assistance (404) makes the decision of visualized component based on Result Producer Assistance particulars with Precepts (404.4.1). As a result, it cognizes standard visualized component (404.5) and retain as (404.6) in standard visualized component (404.n). Based on the request and intermediate response, user provides satisfactory feedback. User's assessment evaluation (405) evaluate the solution of mechanized intellect. Generated Solution can be correct or incorrect, complete or incomplete, finite or infinite. Expert User provide the feedback for the asked property and store in Feedback (405.n). User's Assessment Evaluation consists of Evaluation of User's Request for Cognition 401 Factor, Evaluation of Computer Resource Determiner 402 Factor, Evaluation of Generic Query Conversion 403 Factor, Evaluation of Result Producer Assistance 404 Factor. In other examples, fewer or more steps may be provided or enhanced or extended occurring within and/or outside steps in the example of FIG. 4(a) to FIG. 4(e). The Present disclosure may be used in various domain independent or dependent area at contextual situation via diverse natural language usage for diverse computer resources.

Referring to FIG. 5, the present intellect implementation (511) is a solution of the orchestration process of Mechanized Intellect. Said Process is implemented as an application (510) that resides in an operating system (509). Said Implementation (511) requires processor (503), and network interface (504) to communicate. Further said implementation (511) Storage Device (505), and Memory (506). To interact with implementation, User Interface (507) provides input and output solution. In one of the example storage device(s) (505) may include computer resource(s) (602) that specifies resources are on the same machine. Interaction to the System would be via the network interface (504), and User Interface (507). The power Source (508) supplies power to the implementation (511) to activate. Each of components 503, 504, 505, 506, 507, 508, 509,510, and 511 may be interconnected operatively, physically or/and communicatively for intercomponent communications. An Orchestration Device (500) may include additional components and run different application. Although each of MI device (500) may be mobile; or stationary or mobile portable, etc. In some example single user may own MI device for the orchestration process. In Another example, two or more users may share MI device for the orchestration. Conceptually, Mechanized Intellect Orchestration Device(s) (500x) connects for communicating Subjects on Computer Resource(s) (602) on another thing(s)/device(s)/apparatus(s) (601) via network (603). In some examples, MI Device (500) utilizes network interface (504) to wirelessly communicates with (601) such as mobile phone, server, or other networked computing devices, etc. Computing environment of (601) utilize one or more same components as MI Device (500). In one of the examples (500x) signifies one or more (500) devices used for the single orchestration process. In another example (500x) specifies the distribution of complete (500) MI process on multiple devices. In another example, one device of (500x) connects to the other device of (500x) via network (603) such as wired or wireless network.

User Interface (507) may be a touch screen interface. In some examples (507) may include a display and one or more buttons, pad, joysticks, mouse, tactile devices, sound card, graphics adapter card, or any other input/output devices capable of turning user actions into electrical signals that control the orchestration device (500). In some example, MI device (500) may include one or more User Interface (507). User Interface (507) may include, separate or combined from input devices, output devices. In addition, User Interface (507) may include but are not limited to, speaker, monitor, a liquid crystal display, light emitting diode array, and/or converting signal into appropriate user or machine understandable form, or other type of the device that generate output, etc.

Here, considers one example where 500x.1 is first MI device, and 500x.2 is second device. In this example, out of two devices, one of the 500x.1 device configures, and manages orchestration process and another 500x.2 device coordinates to the first device and uses interface of the second device. In some examples complete orchestration process is on single MI device. Subject on Computer Resource(s) (602) include but not limited to, Language, domain, Computer resource contents, contextual situations, etc. Details of (602) are explained in preceding explanation of subjects(s). In Some examples, subject on Computer Resource(s) (602) may be included within MI device (500) itself.

Memory (506), in one example is described as computer-readable storage medium. Memory in some example, is configured to store information within orchestration device (500) during operation. In some examples, Memory includes but are not limited to, temporary memory; volatile memory such as Random-access memories (RAM), dynamic Random-access memories (DRAM), static Random-access memories (SRAM), etc. Memory (506) in one example, is used by applications (510) running on computing device (500) to temporarily store information during program execution by one or more Processor (503). In one example, MI process is dynamically loaded on Processor (503). In some examples, MI process is hard coded in Processor (503) at MI Device (500).

In another embodiment Mi Device (500) may include Network interface (504). In another embodiment, Mi Device (500) utilizes Network interface (504) to communicate with external thing(s)/device(s)/apparatus(s) (601) via network (603). Network (603) may be a single network, or network (603) may be representative of one or more networks that allow MI device (500) to communicate to another thing(s)/device(s)/apparatus(s) (601).

Network (603) may be with any communicating protocol that enables data transfer between two or more devices. Network (603) may include but are not limited to, WiFi, Local Area Network (LAN), 3G, 4G, WiMax, cellular network, satellite network, etc. incorporated as one or more of internet, fiber optic network, or wired network. Network interface (504) include but are not limited to, an optical transceiver, Ethernet card, a radio frequency transceiver, 3G, 4G, WiFi in mobile computing devices, USB, or any other type of device that can send and receive information.

Storage device (505) may be configured to store large information than memory (506). The embodiments disclosed herein may be recorded in Storage device (505). Under situations, Storage device (505) may include one or more computer readable storage media. Storage device (505) may be configured for long-term storage of information. In Another embodiment, Storage device (505) include but are not limited to, non-volatile storage such as optical disc, CD, DVD, floppy disc, magnetic hard disc, flash memories, or electrically erasable and programmable memories (EEPROM), electrically programmable memories (EPROM), etc.

In another embodiment, MI device (500) includes one or more power source(s) (508) that may provide power to (500). In some examples, power source (508) may be capable of providing stored power or voltage from another stored energy such as capacitors, fuel cells, etc. Power source (508) may include a battery and/or circuit for generating power from an AC or DC power source.

Operating system (509), under situations, controls the operation of components of MI device (500). In one example, Operating system (509) facilitates the operation of application (510) with processor (503), network interface (504), storage device (505), Memory (506) 20 and user interface (507).

Application (510) may be a software and/or hardware module. In some examples Application (510) may be sub-routine of Operating system (509) or software independent from Operating system (509) or sub-modules that executes diverse aspects of communicating process. In some example the user may initiate application from the list of applications (510). Any Application (510) or modules implemented within, processed by, operable by, executed by, communicated by the components of the MI Device (500).

### Advantages of Invention

The present invention provides an orchestration process by configuring, coordinating, and managing that mimics human intellect as mechanized intellect of Cognitive Science.
The present invention provides mechanized intellect that acquires, applies, and examines the solution.
The present invention provides an intelligent retrieval skill that contributes problem solving and facilitates the decision making
The present invention provides a computing process of intelligent retrieval from diverse computer resources using human connatural language.
The present invention generates generic to specific meta-content of the subjective outcome that is beneficial to cognize the subjects and helpful in IQ, and IP.
The present invention analyzes MI way human connatural language-based user's request.
The present invention provides Particulars with Precepts Approach using MI Convergence to determine the Computer Resource, to convert to standard technical query, and to assist the result producer.

1. A Mechanized intellect Orchestration Comprising of process and device Wherein, Said process comprises of Configuring, coordinating, and managing
Mechanized Intellect Abilities,
Factors of Mechanized Intellect Meta Model,
Intelligent Retrieval skill;
Wherein,
Said mechanized intellect abilities comprises of:
Intellect acquiring (IQ),
Intellect applying (IP),
Intellect examining (IX);
Said factors of Mechanized Intellect Meta Model comprises of subject(S), Function (F), and Outcome (O); Said, intelligent retrieval utilizes the mechanized intellect abilities and said factors of mechanized intellect meta model to intelligently retrieve from diverse source of computing sources utilizing human connatural language (HKL).

2. The computing process of intelligent retrieval as claimed in claim 1; wherein the intelligent retrieval is achieved through (IQ), (IP), and (IX); the acquisition of knowledge, the step of cognizing and retention of subject is required to obtain a solution; Cognizing and retention of knowledge is determined by subjects such as Domain (SD), computer resource (SC), language (SL), and contextual Situation (SS) knowledge of subjects. Generic Meta Content is cognized and retained for the subjective outcomes. Cognizing of information and the retention of the same is generic as well as specific; the retention of the acquired intellect solution is obtained for the posed problem and decision making.

3. The process of intelligent retrieval as claimed in claim 1; wherein the Wherein the Intellect Applying (IP) is applied; the user's request (UR) is received in order to produce the solution of the problem, through the acquired information; said user's request (UR) is processed by the cognizing the unit outcome (OU), class outcome (OC), relation outcome (OR) and system outcome (OS) based on the subject Language (SL), subject domain (SD) and Contextual Situation (SS), and apply the divergence function to generate Intermediate Cognized User's Request (401.n) based on Subjective Outcome; said generated Intermediate Cognized User's Request (401.n) is utilized to determine the computer resource (SC) by utilizing CRD Particulars with Precepts (402.5.1) approach; thus acquiring the intellect via recalling language, domain, computer resource, and contextual situation outcome of subjects; Said acquired intellect is utilized to convert the generic query present in natural language to obtain the Standard Technical Query by applying recall and convergence by applying GQC particular with percepts (403.4.1) to obtain Standard Technical Query; Said convergence with particular with percepts (404.4.1) is applied to determine the Standard Visualized Component.

4. The Process for intelligent retrieval as claimed in claim 1; wherein evaluating of the generated response is determined through Intellect Examination Subsystem (IXs).

5. The Orchestration process for Mechanized Intellect abilities, factors and intelligent retrieval as claimed in claim 1; wherein the method acquires, applies, and examines the intellect based on meta factors and thus assists in obtaining solution and decision making.
